(19) United States
(12) Patent Application Publication
(10) Pub. No.: US 2015/0294341 A1
(43) Pub. Date: Oct. 15, 2015

(54) CHECKOUT AMOUNT CALCULATION METHOD AND COMPUTER PROGRAM PRODUCT THEREOF

(71) Applicant: PRESIDENT CHAIN STORE CORP., Taipei (TW)

(72) Inventors: CHIH-YUNG CHANG, Taipei (TW); CHIA-YIN TSAI, Taipei (TW)

(21) Appl. No.: 14/517,990

(22) Filed: Oct. 20, 2014

(30) Foreign Application Priority Data
Apr. 9, 2014 (TW) 103113109

(51) Int. Cl. G06Q 30/02

(52) U.S. Cl. CPC G06Q 30/0222

(57) ABSTRACT

A checkout amount calculation method includes receiving a plurality of groups of commodity information, generating a first discount quantity according to a preset discount condition and the received commodity information by using a processing unit, receiving a first trigger signal according to the first discount quantity, generating a first group of discount numerical values according to the first trigger signal, calculating a checkout amount according to the first group of discount numerical values and the received commodity information, and displaying the checkout amount, where, each group of commodity information corresponds to a commodity to be purchased, and a quantity of the discount numerical values in the first group of discount numerical values is equal to the first discount quantity.

### CROSS-REFERENCES TO RELATED APPLICATIONS

This non-provisional application claims priority under 35 U.S.C. §119(a) on Patent Application No. 103113109 filed in Taiwan, R.O.C. on 2014/04/09, the entire contents of which are hereby incorporated by reference.

### BACKGROUND

1. Technical Field

The present invention relates to a checkout amount calculation method and a computer program product thereof.

2. Related Art

Business competitions between various industries are very intense nowadays. How to develop a new product to attract a consumer to generate a transaction behavior and then to obtain a business opportunity has become a key that determines whether an enterprise or a merchant can continue operation and survive. A traditional commodity transaction mode is that a consumer personally goes to a physical store and purchases a wanted commodity. However, with vigorous development of network technologies, many virtual stores are developed, to provide a new and convenient consumption way for the consumer that is originally limited by locality.

To continuously attract purchasing of the consumer, many merchants launch different kinds of preferential schemes, to stimulate consumption of the consumer. These preferential schemes include a discount, a giveaway, a cumulative bonus prize claiming, and the like. However, the giveaway and prize mode (the giveaway and the cumulative bonus prize claiming) often cannot comprehensively satisfy the consumer. A main reason lies in that a user cannot have a feeling of a direct reward and real money-saving.

In a discount mode, generally a price of the commodity is directly adjusted or a coupon is provided. However, these manners can only provide a fixed discount for a same commodity, but cannot randomly adjust the discount. In addition, traditional coupons are all provided in a form of paper, and are not enough in environment-friendliness; and when a coupon is used, time needs to be spent on inputting discount information that the coupon represents into a POS cash register, which is not convenient. Hereof, POS is an abbreviation of point of sale, and is EPOS (electronics at the point of sale) for short in Europe. At present, many merchants change English “point of sale” to “point of service”.

A key point of it is to stimulate wishes of new and old consumers for consumption or re-consumption, so that the business volume of the operation of the enterprise or merchant can continuously grow.

### SUMMARY

In an embodiment, a checkout amount calculation method includes receiving a plurality of groups of commodity information, generating a first discount quantity according to a preset discount condition and the received commodity information by using a processing unit, receiving a first trigger signal according to the first discount quantity, generating a first group of discount numerical values according to the first trigger signal, calculating a checkout amount according to the first group of discount numerical values and the received commodity information, and displaying the checkout amount, where, each group of commodity information corresponds to a commodity to be purchased, and a quantity of the discount numerical values in the first group of discount numerical values is equal to the first discount quantity.

In an embodiment, a computer program product can implement the foregoing checkout amount calculation method after a program is loaded and executed by a computer.

In summary, according to a checkout amount calculation method of the present invention, when a consumer checks out, whether the consumer is qualified to participate in a discount activity can be automatically judged, an interactive discount activity and a random discount amount are provided, and a checkout amount is adjusted according to the discount amount, to simply and quickly provide a checkout manner with the random discount amount, so as to provide a feeling of money-saving that is interesting and gives a most direct reward to the consumer, and then stimulate wishes of new and old consumers for consumption or re-consumption.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a POS (point of service) cash register according to an embodiment of the present invention;

FIG. 2 is a three-dimensional block diagram of a POS (point of service) cash register according to an embodiment of the present invention;

FIG. 3 to FIG. 7 are outline flowcharts of a checkout amount calculation method according to an embodiment of the present invention;

FIG. 8 is a schematic diagram of a first implementation state of a display screen of a second display unit;

FIG. 9 is a schematic diagram of a first implementation state of a display screen of a first display unit;

FIG. 10 is a schematic diagram of a second implementation state of a display screen of a first display unit;

FIG. 11 is a schematic diagram of a second implementation state of a display screen of a second display unit;

FIG. 12 is a schematic diagram of a third implementation state of a display screen of a second display unit; and

FIG. 13 is a schematic diagram of a third implementation state of a display screen of a first display unit.

### DETAILED DESCRIPTION

A checkout amount calculation method according to the present invention can be used in a physical store or a virtual store, to interact with a consumer to perform a real-time and random preferential activity. Hereof, the checkout amount calculation method according to the present invention can be implemented by executing a firmware or software algorithm by using a processing unit.

Using the physical store as an example, the checkout amount calculation method according to the present invention can be applied to a POS (point of service) cash register in a stand-alone manner. For example, an archive is established for a relevant activity of a preferential activity in headquarters, and then the archive is distributed to background servers of various retail stores through a network, and finally is further distributed to various POS cash registers in the retail stores and used. When the archive is established in the headquarters, besides that a software program for implementing the checkout amount calculation method is established, a discount condition of the preferential activity may also be set.

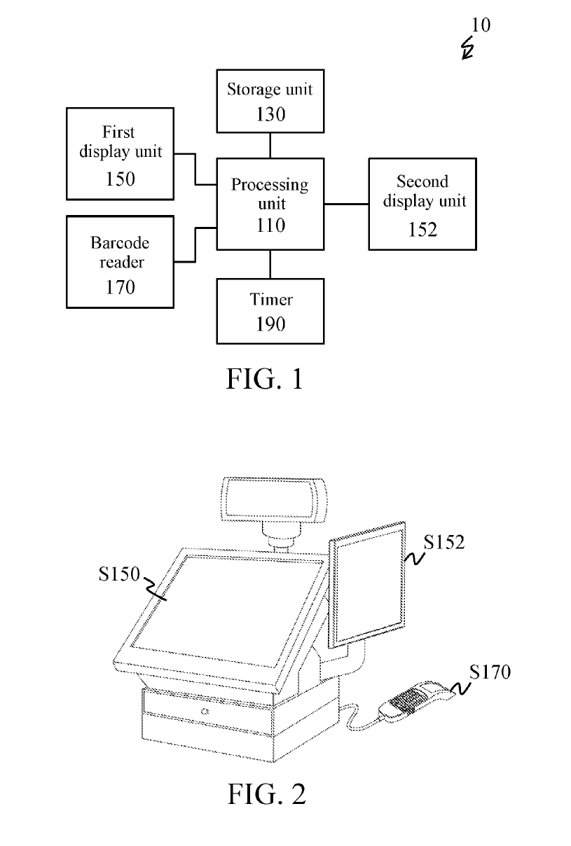

Referring to FIG. 1 and FIG. 2, a POS cash register 10 includes a processing unit 110, a storage unit 130, two display units (hereinafter referred to as a first display unit 150 and a second display unit 152), and a barcode reader 170. The storage unit 130, the first display unit 150, the second display unit 152, and the barcode reader 170 are electrically connected to the processing unit 110.

Hereof, the first display unit 150 is a salesclerk-end display, and the second display unit 152 is a consumer-end display.

The storage unit 130 stores a preset parameter that is needed to execute software, for example: information such as a discount condition, a discount numerical value, a probability of each lot (a range of a system random numerical value), the number of seconds for drawing lots (a given time), and drawing animation playing time. The discount condition may include a type of an activity to be participated in (a given type) and/or a required quantity of a started activity, and the like. In addition, the storage unit 130 is further used to temporarily store various parameters that are generated in a process of executing the software, for example: inputted commodity information about a commodity to be purchased, a checkout list, the number of times that lots can be drawn, the number of times that lots have been drawn, a drawing result that is produced, and the like, where, the storage unit 130 may be implemented by one or more storage components. Hereof, a storage component may be, for example, a memory or a register, and is not limited herein. The memory may be, for example, a read-only memory, a random access memory, a non-permanent memory, a permanent memory, a static memory, a dynamic memory, a flash memory and/or any device for storing digital information.

The processing unit 110 may be implemented by one or more processing components. A processing component may be a microprocessor, a microcontroller, a digital signal processor, a microcomputer, a central processing unit, a field programmable gate array, a programmable logic device, a state machine, a logic circuit, an analog circuit, a digital circuit and/or any device that operates a signal (analog and/or digital) based on an operation instruction.

For convenient description, the following describes an operational manner of the POS cash register 10 by using an example in which the two display units are used as a touch-screen. However, the present invention is not limited thereto. In some embodiments, one or more input units (for example: a keyboard, a mouse, a physical button, or the like) may also be additionally set for the POS cash register 10, for a salesclerk and/or a consumer to operate the POS cash register 10.

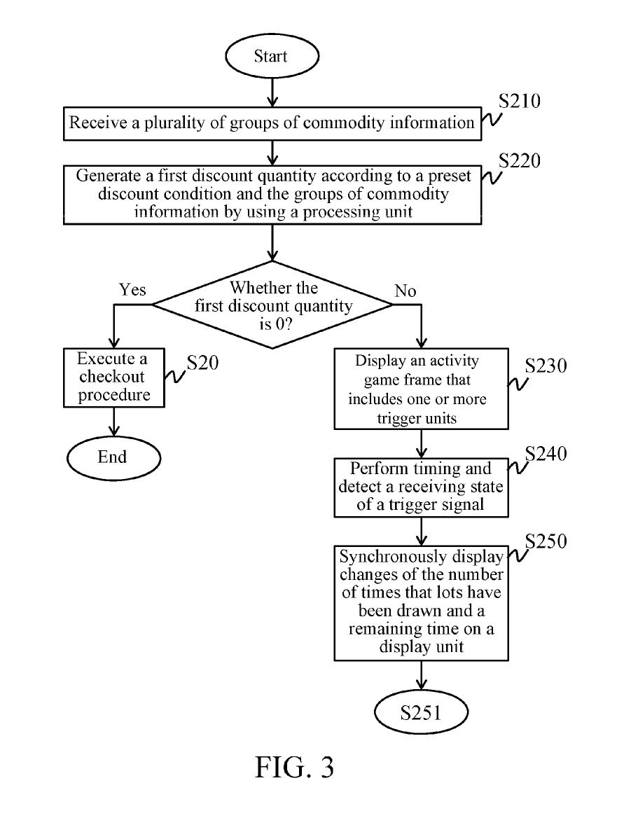

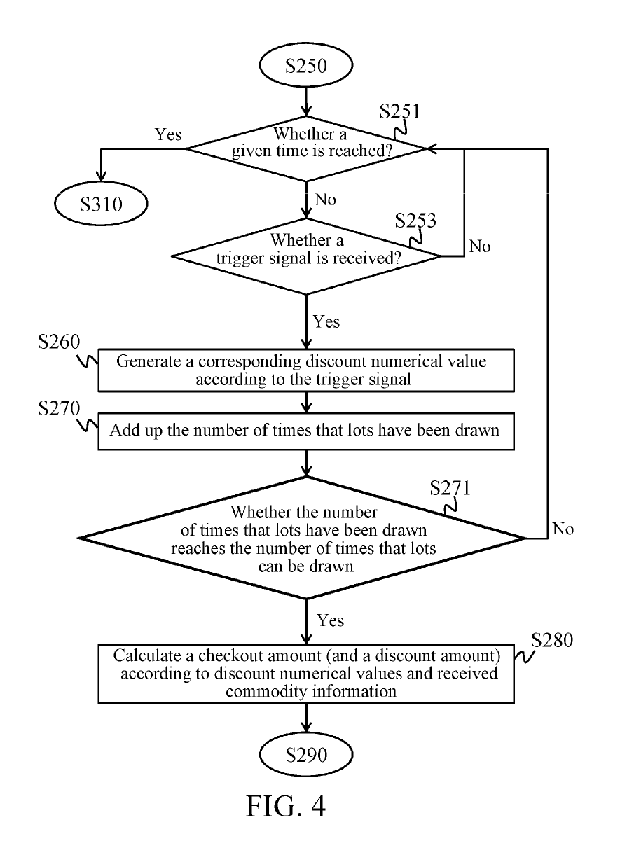

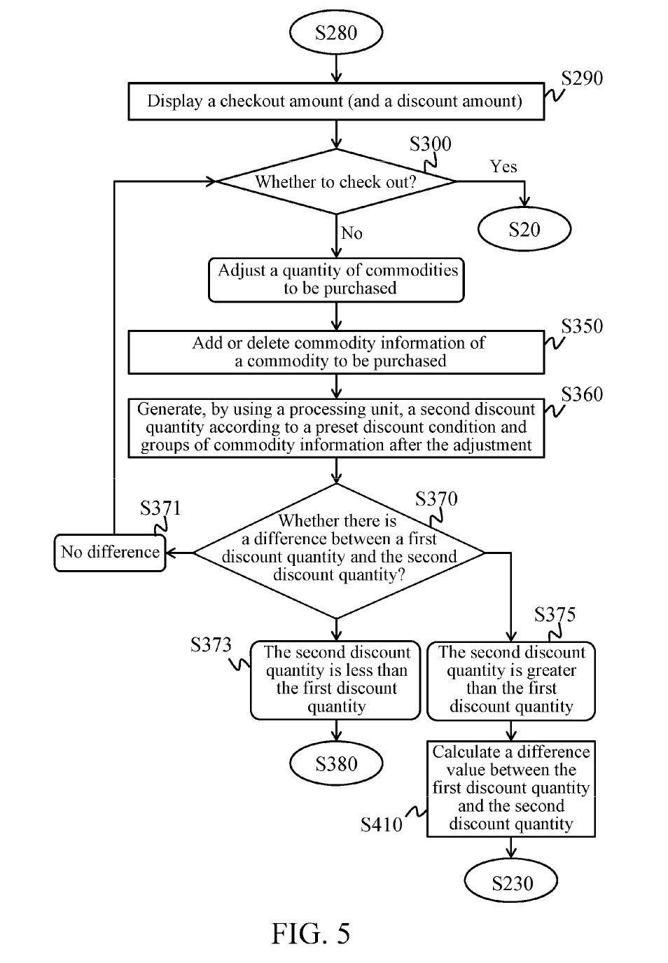

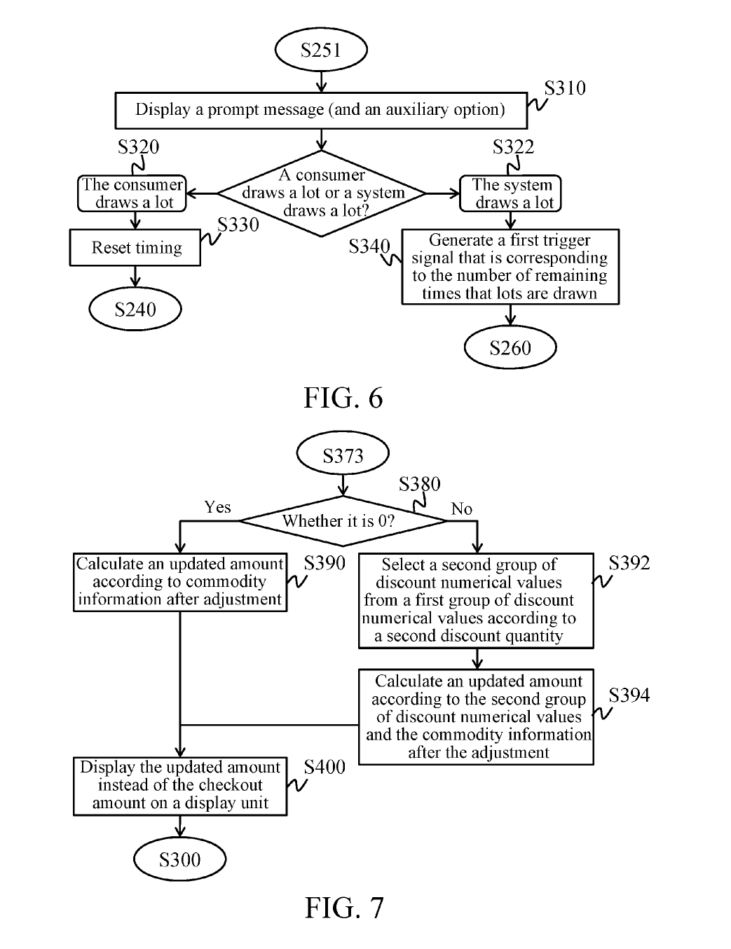

Referring to FIG. 1 to FIG. 7, after the consumer selects commodities that the consumer wants to purchase (hereinafter referred to as commodities to be purchased), the salesclerk inputs commodity information about these commodities to be purchased into the POS cash register 10 by using the barcode reader 170, to create a checkout list that is corresponding to these commodities to be purchased. Hereof, each commodity has a corresponding group of commodity information. Each group of commodity information at least has a commodity name, a commodity type, and a commodity price. For example, each commodity has a commodity label, and texts such as the commodity name, the commodity type, the commodity price, and a consumption time limit such as a date and time of manufacturing or processing, and a commodity barcode are printed on each commodity label. The salesclerk scans commodity barcodes of the commodities to be purchased by using the barcode reader 170, and the processing unit 110 can receive and obtain, according to the commodity barcodes, the commodity information such as the commodity name, the commodity type, and the commodity price of a corresponding commodity to be purchased (step S210). At the same time, the processing unit 110 displays the received commodity information on the first display unit 150 for the salesclerk to confirm. In addition, the processing unit 110 may also synchronously display the received commodity information on the second display unit 152 for the consumer to confirm.

The salesclerk presses a customer button after the commodity information about the commodity to be purchased is inputted, and then the processing unit 110 generates a first discount quantity according to a preset discount condition and the received commodity information (step S220). For example, the preferential activity is discount drawing for 2 cans of beverages. At this time, the preset discount condition is that the given type is beverage and the required quantity is 2. The processing unit 110 compares commodity types in each group of commodity information according to the given type, to confirm a quantity of the beverages in the commodities to be purchased, and then calculates the number of times that lots can be drawn according to the obtained quantity of the beverages. For example: if the consumer purchases 3 cans of the beverages that comply with the preferential activity, the processing unit 110 obtains through calculation that the first discount quantity (that is, the number of times that lots can be drawn) is 1, where, the first discount quantity is an integer.

When the first discount quantity is 0 (that is, the discount condition is not met), the processing unit 110 executes a checkout procedure according to the commodity price in the received commodity information (step S20).

When the first discount quantity is not 0 (that is, the discount condition is met), the processing unit 110 calls a customer display end to open an activity game frame of a lucky drawing activity, and switches the second display unit 152 from displaying a common frame to displaying an activity game frame 50 (step S230).

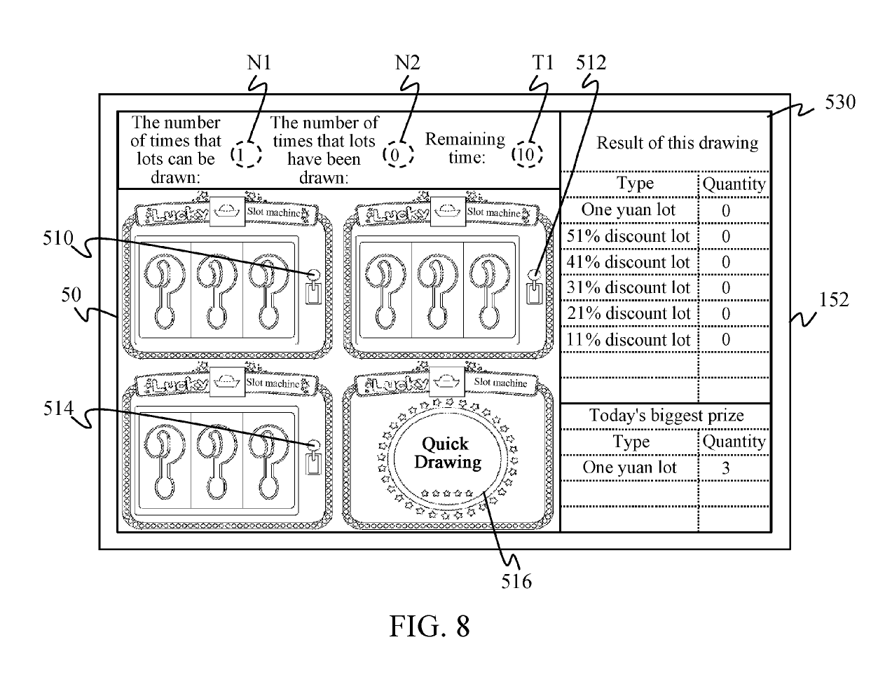

With reference to FIG. 8, the activity game frame 50 includes one or more trigger units 510, 512, 514, and 516 and a drawing information column 520, where, the trigger units 510, 512, 514, and 516 may each be a virtual button, a virtual slot machine rod, a physical button, or the like. There is drawing information in the drawing information column 520. Hereof, the drawing information includes the number of times that lots can be drawn N1, the number of times that lots have been drawn N2, and a remaining time T1. In other words, the drawing information such as the number of times that lots can be drawn N1, the number of times that lots have been drawn N2, and the remaining time T1 is displayed in the drawing information column 520 of the processing unit 110 on the second display unit 152, for the consumer to confirm a drawing progress state.

In addition, the activity game frame 50 further includes a result statistics column 530. A statistical result of a drawing result (that is, the discount numerical value) that has been generated can be presented in the result statistics column 530. Hereof, in the result statistics column 530, there are multiple quantity columns that are corresponding to all preset discount numerical values. These quantity columns separately correspond to different discount numerical values, and in each quantity column, a statistical quantity of the corresponding discount numerical value is presented.

The trigger units 510, 512, 514, and 516 are provided for the consumer to perform trigger, to generate the drawing result (that is, the discount numerical value), where, the trigger units 510, 512, and 514 can obtain one drawing result (that is, one discount numerical value) in each trigger. The trigger unit 516 can obtain drawing results of the number of remaining times that lots are drawn (that is, the number of times that lots can be drawn N1 minus the number of times that lots have been drawn N2) in each trigger. For example, it is assumed that when the first discount quantity is 3 and the consumer has not performed any drawing, the trigger of the trigger unit 516 can correspondingly generate 3 discount numerical values.

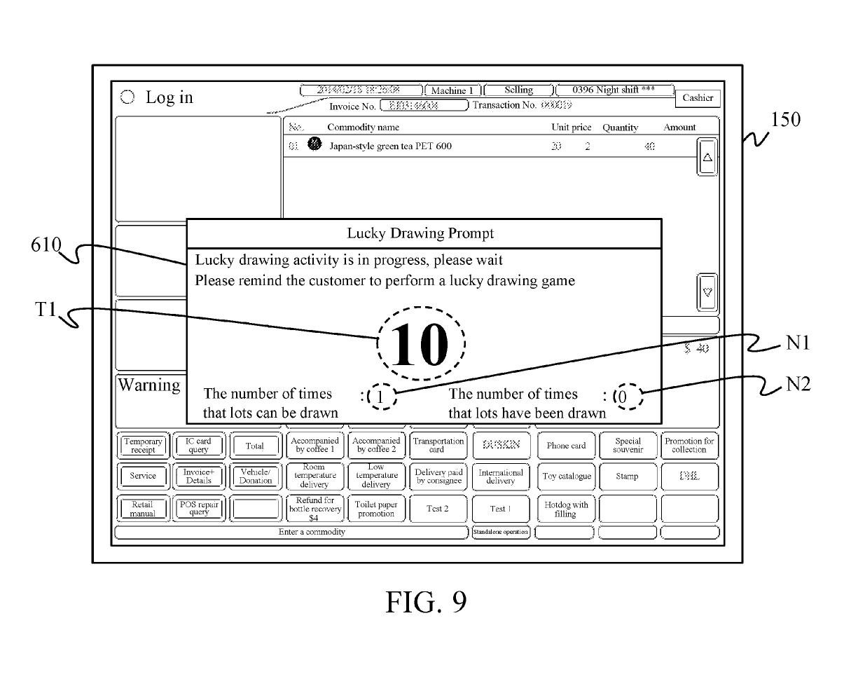

After the activity game frame is displayed, the processing unit 110 triggers a timer 190 to perform timing according to a given time and detect a receiving state of a trigger signal (step S240). In a process of the timing, the processing unit 110 synchronously displays, in the drawing information column 520 on the second display unit 152, changes of the number of times that lots have been drawn N2 and the remaining time T1 that reaches the given time (step S250). In addition, the processing unit 110 can display a prompt message 610 that includes the drawing information on the first display unit 150. In addition, in the process of the timing, the processing unit 110 also synchronously displays, in the prompt message 610 on the first display unit 150, changes of the number of times that lots have been drawn N2 and the remaining time T1 that reaches the given time, for the salesclerk to confirm a current drawing progress state (step S250), as shown in FIG. 9. Hereof, the prompt message 610 is presented in a form of a pop-up window.

When the consumer touches any one of the trigger units 510, 512, and 514, the trigger unit 510, 512, or 514 that is touched generates a trigger signal. When the consumer touches the trigger unit 516, the trigger unit 516 that is touched generates a trigger signal that corresponds to the first discount quantity.

When the processing unit 110 receives the trigger signal (hereinafter referred to as the first trigger signal) within the given time (step S253), the processing unit 110 generates the corresponding discount numerical value according to the first trigger signal (step S260), and correspondingly adds up the number of times that lots have been drawn N2 (step S270). At this time, the processing unit 110 synchronously adds up the statistical quantity of the corresponding discount numerical value, and changes the statistical quantity displayed in the corresponding quantity column in the result statistics column 530 to the statistical quantity after the add-up. For example, when the generated discount numerical value is a 21% discount, 0 changes to 1 in a quantity column of a 21% discount lot.

And then, the processing unit 110 confirms whether the number of times that lots have been drawn N2 reaches the number of times that lots can be drawn N1 (step S271). If the number of times that lots have been drawn N2 does not reach the number of times that lots can be drawn N1, the processing unit 110 returns to detect the first trigger signal and confirm whether timing time reaches the given time (step S251) and then continues to execute the follow-up steps.

If the number of times that lots have been drawn N2 reaches the number of times that lots can be drawn N1, at this time a quantity of generated discount numerical values (hereinafter referred to as the first group of discount numerical values) is equal to the first discount quantity, and the processing unit 110 calculates a checkout amount according to the first group of discount numerical values and the received commodity information (step S280). For example, a discount operation is performed by using the discount numerical values (from a large discount to a small discount), according to a descending order of commodity prices, for the commodities to be purchased that comply with the lucky drawing activity, to obtain amounts after discounts. And then, the amounts after discounts of the commodities to be purchased and commodity prices of commodities to be purchased that do not comply with the lucky drawing activity are added together, to obtain the checkout amount.

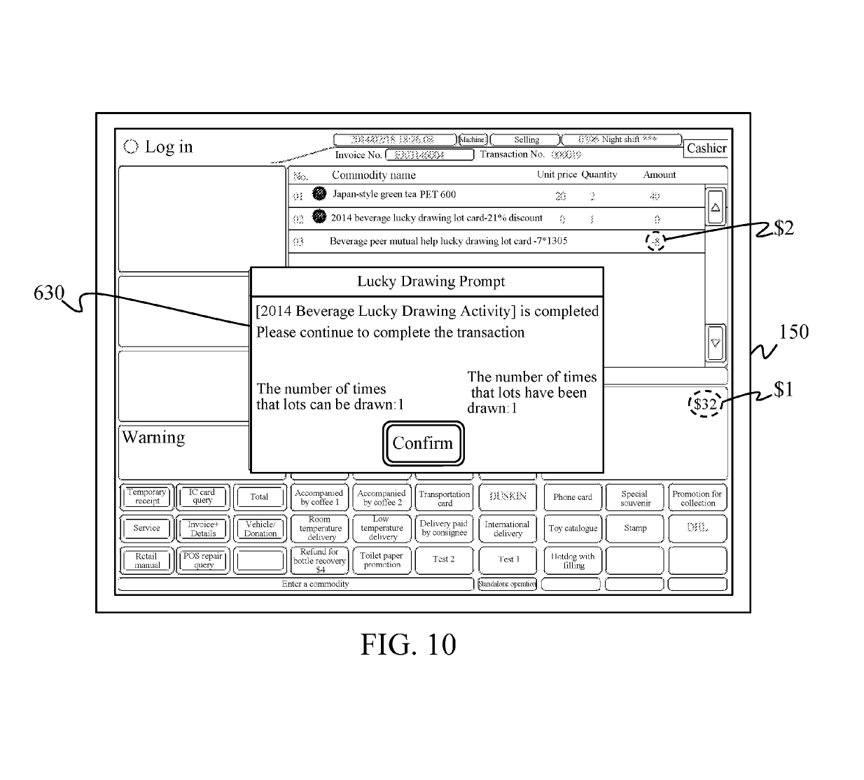

In addition, the processing unit 110 displays the checkout amount on the first display unit 150 (step S290), as shown in FIG. 10.

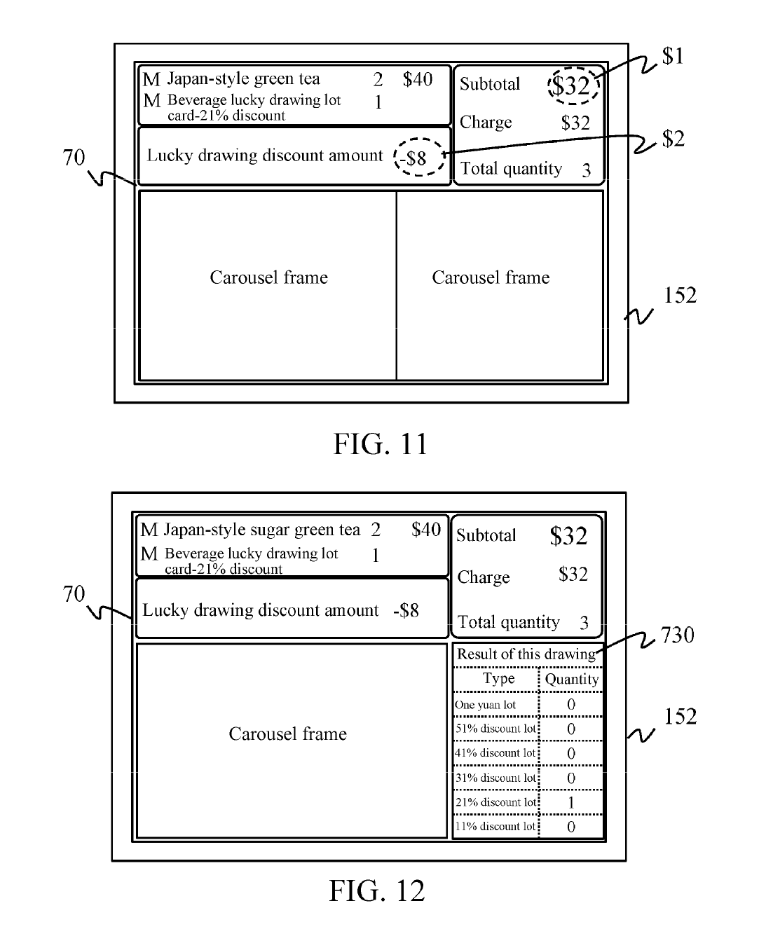

In addition, the processing unit 110 can also display the checkout amount on the second display unit 152 at the same time (step S290). For example, after the drawing is completed (the number of times that lots have been drawn N2 reaches the number of times that lots can be drawn N1), the processing unit 110 switches the second display unit 152 from displaying the activity game frame 50 to displaying a checkout frame 70, and at the same time, displays a checkout amount $1 in a checkout frame 70 on the second display unit 152, as shown in FIG. 11.

In some embodiments, in step S280, the processing unit 110 further calculates a discount amount $2 according to the first group of discount numerical values and the received commodity information. And then, in step S290, the processing unit 110 can display the checkout amount $1 and the discount amount $2 at the same time.

In some embodiments, referring to FIG. 12, the checkout frame 70 may also have a result statistics column 730. Hereof, the result statistics column 730 presents a statistical quantity (add-up quantity) of all drawing results that meet all preset discount numerical values, where, content of the result statistics column 730 may be equal to content of the result statistics column 530 when the number of times that lots have been drawn N2 reaches the number of times that lots can be drawn N1.

If timing of the timer 190 reaches the given time and the processing unit 110 has not received the first trigger signal that is corresponding to the first discount quantity (that is, the first trigger signal is not received at all or the number of times that lots have been drawn N2 does not reach the number of times that lots can be drawn N1) (step S251), the processing unit 110 displays a prompt message 620 that includes information about uncompleted drawing on the first display unit 150, to instruct the salesclerk to remind the consumer to draw lots or ask the consumer whether the salesclerk needs to draw lots on behalf of the consumer (step S310).

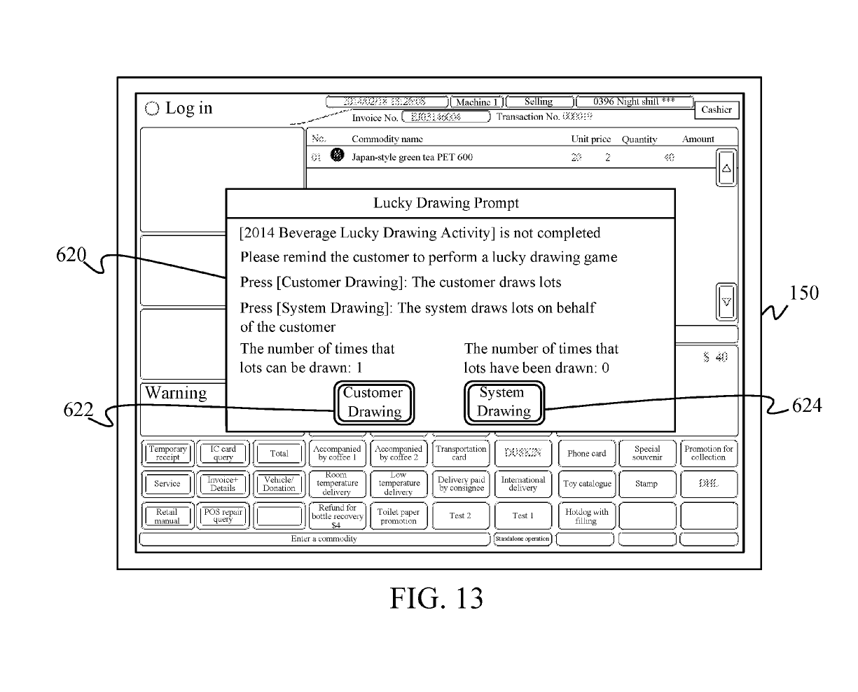

In some embodiments, in step S310, the processing unit 110 further provides an auxiliary option (for example, virtual buttons 622 and 624 shown in FIG. 13, which separately represent consumer drawing and system drawing) on the first display unit 150, to make the salesclerk conveniently operate the POS cash register 10 to control a continuously running procedure. Hereof, the virtual buttons 622 and 624 may appear with the prompt message 620. In some embodiments, the virtual buttons 622 and 624 are located in a window of the prompt message 620.

When the salesclerk presses the virtual button 622 that represents the consumer drawing (step S320), the processing unit 110 resets the timer 190 (step S330) and returns to execute a consumer drawing procedure (returns to step S240).

When the salesclerk presses the virtual button 624 that represents the system drawing (step S322), in response to the pressing on the virtual button 624, a touch module of the first display unit 150 generates the first trigger signal that is corresponding to the number of remaining times that lots are drawn (the number of times that lots can be drawn N1 minus the number of times that lots have been drawn N2) (step S340). After receiving the generated first trigger signal, the processing unit 110 continues to perform step S280.

After all drawing is completed (the number of times that lots have been drawn reaches the number of times that lots can be drawn), the processing unit 110 displays prompt message 630 that includes information about completed drawing on the first display unit 150, to instruct the salesclerk to operate the POS cash register 10 to continue to enter the checkout procedure, cancel a transaction, or adjust (increase or decrease) a quantity of the commodities to be purchased (step S300), as shown in FIG. 10.

When the consumer determines to check out, the salesclerk operates the POS cash register 10 to continue the checkout procedure (step S20).

When the consumer needs to add or remove a commodity to be purchased, the salesclerk can input commodity information of the newly added commodity to be purchased into the POS cash register 10 by using the barcode reader 170 again, or operate the POS cash register 10 by using an input unit, to delete commodity information of any commodity to be purchased in the checkout list. At this time, the processing unit 110 correspondingly adds or deletes commodity information of a commodity to be purchased in the checkout list (step S350).

And then, the processing unit 110 generates a second discount quantity according to the preset discount condition and the commodity information after the adjustment (the addition or deletion) (step S360), and compares the first discount quantity and the second discount quantity to obtain a difference (step S370).

When there is no difference between the two (step S371), the processing unit 110 returns to step S300, to wait to continue to enter the checkout procedure, cancel the transaction, or adjust (increase or decrease) the quantity of the commodities to be purchased (step S300).

When the second discount quantity is less than the first discount quantity (step S373), the processing unit 110 confirms whether the second discount quantity is 0 (step S380). When the second discount quantity is 0, the processing unit 110 directly calculates an updated amount according to the commodity information after the adjustment (step S390), and displays the updated amount instead of the checkout amount on the first display unit 150 and the second display unit 152 (step S400). When the second discount quantity is not 0, the processing unit 110 selects a second group of discount numerical values from the first group of discount numerical values according to the second discount quantity (step S392). In other words, in the second group of discount numerical values, the quantity of the discount numerical values is equal to the second discount quantity. And then, the processing unit 110 calculates an updated amount according to the second group of discount numerical values and the commodity information after the adjustment (step S394), and displays the updated amount instead of the checkout amount on the first display unit 150 and the second display unit 152 (step S400).

In step S392, the processing unit 110 can first sort the first group of discount numerical values according to discount magnitude, and then sequentially select discount numerical values, whose discounts are the largest and whose quantity is equal to the second discount quantity, as the second group of discount numerical values. For example, it is assumed that the first discount quantity is 5 and the corresponding first group of discount numerical values are separately 51% discount for 1 piece, 31% discount for 1 piece, 21% discounts for 2 pieces, and 11% discount for 1 piece. After the quantity of the commodities to be purchased is adjusted, the processing unit 110 calculates that the second discount quantity is 3. At this time, the processing unit 110 selects 3 largest discounts, that is, 51% discount for 1 piece, 31% discount for 1 piece, and 21% discount for 1 piece, from the first group of discount numerical values.

When the second discount quantity is greater than the first discount quantity (step S375), the processing unit 110 calculates a difference value between the first discount quantity and the second discount quantity (step S410), calls the customer display end again according to the difference value to open the activity game frame, and switches the second display unit 152 from displaying the checkout frame 60 to displaying the activity game frame 50, that is, returns to step S230 and continues to perform subsequent steps.

In the subsequent steps, the processing unit 110 receives the trigger signal (hereinafter referred to as a second trigger signal) according to the difference value (that is, the number of times that lots can be drawn), and generates corresponding discount numerical values (hereinafter referred to as the second group of discount numerical values) (step S240 to step S271) according to the trigger signal. If the number of times that lots have been drawn N2 reaches the number of times that lots can be drawn N1, at this time a quantity of the newly generated discount numerical values (hereinafter referred to as the second group of discount numerical values) is equal to the difference value, and the processing unit 110 calculates a checkout amount again according to the discount numerical values (including the first group of discount numerical values and the second group of discount numerical values) and the commodity information after the adjustment (step S280). In addition, the processing unit 110 displays the checkout amount on the display unit again (step S290).

In some embodiments, the processing unit 110 can reset the timer 190 (reset the timing) when (or after) the trigger signal is received each time, or reset the timer 190 (reset the timing) when (or after) drawing behaviors of the number of times that all lots are drawn (that is, the number of times that lots have been drawn N2 reaches the number of times that lots can be drawn N1) are completed for ease of use in a next timing requirement.

In some embodiments, a method of generating, by the processing unit 110 according to the trigger signal (the first trigger signal or the second trigger signal), the corresponding discount numerical values may be implemented by the following manner.

The storage unit 130 stores multiple preset system random numerical values and a correspondence between the system random numerical values and the discount numerical values, as shown in the following Table 1 or Table 2.

TABLE 1

| | | |
|---|---|---|
| Discount | | System Random |
| Numerical Value | Probability | Numerical Value |

| | | | |
|---|---|---|---|
| 1 | yuan | 1% | 1 |
| 51% | discount | 5% | 2 to 6 |
| 41% | discount | 13% | 7 to 19 |
| 31% | discount | 21% | 20 to 40 |
| 21% | discount | 30% | 41 to 70 |
| 11% | discount | 30% | 71 to 100 |

TABLE 2

| | | |
|---|---|---|
| Discount | | System Random |
| Numerical Value | Probability | Numerical Value |

| | | | |
|---|---|---|---|
| 1 | yuan | 0.01% | 1 |
| 51% | discount | 5.99% | 2 to 600 |
| 41% | discount | 13.00% | 700 to 1900 |
| 31% | discount | 21.00% | 2000 to 4000 |
| 21% | discount | 30.00% | 4100 to 7000 |
| 11% | discount | 30.00% | 7100 to 10000 |

Hereof, the system random numerical values are integers, and a range of the system random numerical values can determine the drawing probability of the lucky drawing activity. Using Table 1 as an example, the system random numerical values are limited between 1 and 100, and the minimum probability is 1%. Using Table 2 as an example, the system random numerical values are limited between 1 and 10000, and the minimum probability is 0.01%.

In response to the trigger signal, the processing unit 110 randomly selects a corresponding quantity of numerical values (hereinafter referred to as a selected random numerical value) from the preset system random numerical values. For example, when the discount quantity is 3, in response to the trigger signal, the processing unit 110 randomly selects 3 selected random numerical values from the preset system random numerical values.

And then, the processing unit 110 converts the selected random numerical values into the corresponding discount numerical values, to obtain a group of discount numerical values.

Using Table 1 as an example, in response to the trigger signal, the processing unit 110 randomly selects 15 and 72 from 1 to 100 according to the discount numerical value (it is assumed that it is 2), and the processing unit 110 obtains two discount numerical values (the 41% discount and the 11% discount) according to 15 and 72.

It should be understood that, in the foregoing embodiments, a sequence in which the steps are described is not intended to limit a sequence in which the steps are performed, and in a reasonable range, the sequence in which the steps are performed may be randomly changed.

If the method is applied to a virtual store, the processing unit 110, the storage unit 130, and the first display unit 150 are remote electronic apparatuses (at this time, the barcode reader 170 may be not included), and the second display unit 152 is a screen of a consumer-end electronic apparatus. Hereof, the second display unit 152 communicates with the processing unit 110 through a network. When the checkout is performed on a consumer end, the commodity information is transmitted by the consumer-end electronic apparatus to the remote electronic apparatuses through the network.

In some embodiments, the checkout amount calculation method according to the present invention may be implemented by a computer program product, so that after a computer (that is, any electronic apparatus that includes the processing unit 110, the storage unit 130, and the input unit, for example: a POS cash register or a server) loads and executes a program, the computer can complete the checkout amount calculation method according to any embodiment of the present invention. In some embodiments, the computer program product may be a readable recording medium, and the foregoing program is stored in the readable recording medium, for a computer to load. In some embodiments, the foregoing program itself may be the computer program product, and is transmitted to the computer in a wired or wireless manner.

In summary, according to a checkout amount calculation method of the present invention, when a consumer checks out, whether the consumer is qualified to participate in a discount activity can be automatically judged, an interactive discount activity and a random discount amount are provided, and a checkout amount is adjusted according to the discount amount, to simply and quickly provide a checkout manner with the random discount amount, so as to provide a feeling of money-saving that is interesting and gives a most direct reward to the consumer, and then stimulate wishes of new and old consumers for consumption or re-consumption.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A checkout amount calculation method, comprising:
receiving a plurality of groups of commodity information, wherein each of the groups of commodity information corresponds to a commodity to be purchased;
generating a first discount quantity according to a preset discount condition and the groups of commodity information by using a processing unit;
receiving at least one first trigger signal according to the first discount quantity;
generating a first group of discount numerical values according to the at least one first trigger signal, wherein a quantity of the discount numerical values in the first group of discount numerical values is equal to the first discount quantity;
calculating a checkout amount according to the first group of discount numerical values and the groups of commodity information; and
displaying the checkout amount.

2. The checkout amount calculation method according to claim 1, further comprising:
receiving a deletion signal;
deleting one of the groups of commodity information according to the deletion signal;
generating a second discount quantity according to the preset discount condition and a remaining plurality of groups of commodity information in the groups of commodity information after the deletion, by using the processing unit;
when the second discount quantity is not equal to the first discount quantity, selecting a second group of discount numerical values from the first group of discount numerical values according to the second discount quantity, wherein a quantity of the discount numerical values in the second group of discount numerical values is equal to the second discount quantity;
calculating an updated amount according to the second group of discount numerical values and the groups of commodity information; and
displaying the updated amount instead of the checkout amount on a display unit.

3. The checkout amount calculation method according to claim 2, wherein the step of selecting the second group of discount numerical values comprises:
sorting the first group of discount numerical values according to discount magnitude; and
selecting discount numerical values, whose discounts are the largest and whose quantity is equal to the second discount quantity from the sorted first group of discount numerical values, as the second group of discount numerical values.

4. The checkout amount calculation method according to claim 1, further comprising:
receiving a deletion signal;
deleting one of the groups of commodity information according to the deletion signal;
generating a second discount quantity according to the preset discount condition and a remaining plurality of groups of commodity information in the groups of commodity information after the deletion, by using the processing unit;
when the second discount quantity is 0, calculating an updated amount according to the groups of commodity information; and
displaying the updated amount instead of the checkout amount on a display unit.

5. The checkout amount calculation method according to claim 1, further comprising:
receiving at least one group of commodity information again;
after the receiving at least one group of commodity information again, generating a second discount quantity according to the preset discount condition and the received groups of commodity information by using the processing unit;
when the second discount quantity is not equal to the first discount quantity, calculating a difference value between the first discount quantity and the second discount quantity;
receiving at least one second trigger signal according to the difference value;
generating a second group of discount numerical values according to the at least one second trigger signal, wherein a quantity of the discount numerical values in the second group of discount numerical values is equal to the difference value;
generating an updated amount according to the first group of discount numerical values, the second group of discount numerical values, and the groups of commodity information; and
displaying the updated amount instead of the checkout amount on a display unit.

6. The checkout amount calculation method according to claim 5, further comprising:
displaying at least one trigger unit, wherein the at least one trigger unit is used to generate the at least one second trigger signal.

7. The checkout amount calculation method according to claim 5, wherein the generating the second group of discount numerical values comprises:
selecting at least one from a plurality of preset system random numerical values as a selected random numerical value, wherein each of the system random numerical values corresponds to one of a plurality of discount numerical values, and a total quantity of the at least one selected random numerical value is equal to the difference value; and
converting the selected random numerical values into the corresponding discount numerical values, to obtain the second group of discount numerical values.

8. The checkout amount calculation method according to claim 5, wherein each of the groups of commodity information comprises a commodity type and a commodity price, the discount condition comprises a given type, and the second discount quantity is a quantity of commodities whose commodity type is the same as the given type in the groups of commodity information.

9. The checkout amount calculation method according to claim 8, wherein the step of generating the second discount quantity comprises: comparing the commodity type in each of the groups of commodity information with the given type, wherein when the given type is the same as the commodity type, the second discount quantity increases by 1.

10. The checkout amount calculation method according to claim 1, wherein each of the groups of commodity information comprises a commodity type and a commodity price, the discount condition comprises a given type, and the first discount quantity is a quantity of commodities whose commodity type is the same as the given type in the groups of commodity information.

11. The checkout amount calculation method according to claim 10, wherein the step of generating the first discount quantity comprises: comparing the commodity type in each of the groups of commodity information with the given type, wherein when the given type is the same as the commodity type, the first discount quantity increases by 1.

12. The checkout amount calculation method according to claim 1, further comprising:
displaying at least one trigger unit, wherein the at least one trigger unit is used to generate the at least one first trigger signal.

13. The checkout amount calculation method according to claim 1, further comprising:
detecting a receiving state of the at least one first trigger signal within a given time;
when the at least one first trigger signal is not received within the given time, displaying a prompt message; and
after the at least one first trigger signal is received, stopping displaying the prompt message.

14. The checkout amount calculation method according to claim 13, when the at least one first trigger signal is not received within the given time, further comprising:
providing an auxiliary option; and
when the auxiliary option is selected, generating the at least one first trigger signal.

15. The checkout amount calculation method according to claim 14, further comprising:
displaying at least one trigger unit, wherein the at least one trigger unit is used to generate the at least one second trigger signal.

16. The checkout amount calculation method according to claim 15, wherein the auxiliary option and the at least one trigger unit are displayed on different display units.

17. The checkout amount calculation method according to claim 13, further comprising:
displaying at least one trigger unit, wherein the at least one trigger unit is used to generate the at least one second trigger signal.

18. The checkout amount calculation method according to claim 17, wherein the prompt message and the at least one trigger unit are displayed on different display units.

19. The checkout amount calculation method according to claim 1, wherein the step of generating the first group of discount numerical values comprises:
selecting at least one from a plurality of preset system random numerical values as a selected random numerical value, wherein each of the system random numerical values corresponds to one of a plurality of discount numerical values, and a total quantity of the at least one selected random numerical value is equal to the first discount quantity; and
converting the selected random numerical values into the corresponding discount numerical values, to obtain the first group of discount numerical values.

20. A computer program product, which can implement the checkout amount calculation method according to claim 1 after a program is loaded and executed by a computer.
